(19) United States
(12) Patent Application Publication
(10) Pub. No.: US 2017/0366667 A1
(43) Pub. Date: Dec. 21, 2017

(54) CONFIGURATION THAT PROVIDES AN AUGMENTED VOICE-BASED LANGUAGE INTERPRETATION/TRANSLATION SESSION

(71) Applicant: Language Line Services, Inc., Monterey, CA (US)

(72) Inventors: Jeffrey Cordell, Carmel, CA (US); James Boutcher, Carmel, CA (US); Lindsay D'Penha, Carmel, CA (US)

(73) Assignee: Language Line Services, Inc., Monterey, CA (US)

(21) Appl. No.: 15/184,900

(22) Filed: Jun. 16, 2016

(51) Int. Cl. H04M 3/493; G06F 17/28; H04W 4/16

(52) U.S. Cl. CPC H04M 3/4936; H04W 4/16; G06F 17/2809; G06F 17/289; H04M 2242/12

(57) ABSTRACT

A computer implemented language interpretation/translation platform is provided. The computer implemented language interpretation/translation platform comprises a processor that receives a request from a mobile computing device for a voice-based language interpretation/translation session. Further, the processor determines a potential language interpreter/translator to perform language interpretation/translation based upon the request. In addition, the processor sends a non-voice augmented feature that is associated with the potential language interpreter/translator to the mobile computing device so that the mobile computing device renders the non-voice augmented feature on a display device of the mobile computing device. The processor also receives an indication from the mobile computing device that the potential language interpreter/translator is accepted by a user associated with the mobile computing device. Further, the processor establishes the voice-based language interpretation/translation session between the mobile device and a communication device associated with the potential language interpreter/translator.

### BACKGROUND

### 1. Field

This disclosure generally relates to the field of language interpretation/translation. More particularly, the disclosure relates to computer implemented language interpretation/translation platforms that provide language interpretation/translation services via voice-based communication.

### 2. General Background

A variety of computer implemented language interpretation/translation platforms, which shall be referred to as language interpretation/translation platforms, may be utilized to receive requests for language interpretation/translations services. Such language interpretation/translation platforms may also provide or provide access to language interpretation/translations services via voice-based communication, e.g., through a telephone call.

During the language interpretation/translation session provided by such systems, the user is often limited to the information that is provided during the language interpretation/translation session. For instance, the user has to rely on audio provided during a telephone call to establish the context of the language interpretation/translation session. Yet, audio data may not be enough by itself for many users to provide adequate context for the language interpretation/translation session. As a result, such systems do not provide optimal user experiences for language interpretation/translation.

### SUMMARY

A computer implemented language interpretation/translation platform is provided. The computer implemented language interpretation/translation platform comprises a processor that receives a request from a mobile computing device for a voice-based language interpretation/translation session. Further, the processor determines a potential language interpreter/translator to perform language interpretation/translation based upon the request. In addition, the processor sends a non-voice augmented feature that is associated with the potential language interpreter/translator to the mobile computing device so that the mobile computing device renders the non-voice augmented feature on a display device of the mobile computing device. The processor also receives an indication from the mobile computing device that the potential language interpreter/translator is accepted by a user associated with the mobile computing device. Further, the processor establishes the voice-based language interpretation/translation session between the mobile device and a communication device associated with the potential language interpreter/translator.

A computer program product is also provided. The computer program product comprises a non-transitory computer readable storage device having a computer readable program stored thereon. When executed on a computer, the computer readable program causes the computer to receive, with a processor, a request from a mobile computing device for a voice-based language interpretation/translation session. Further, when executed on the computer, the readable program causes the computer to determine, with the processor, a potential language interpreter/translator to perform language interpretation/translation based upon the request. In addition, when executed on the computer, the readable program causes the computer to send, with the processor, a non-voice augmented feature that is associated with the potential language interpreter/translator to the mobile computing device so that the mobile computing device renders the non-voice augmented feature on a display device of the mobile computing device. When executed on the computer, the computer readable program also causes the computer to receive, with the processor, an indication from the mobile computing device that the potential language interpreter/translator is accepted by a user associated with the mobile computing device. Further, when executed on the computer, the readable program causes the computer to establish, with the processor, the voice-based language interpretation/translation session between the mobile device a communication device associated with the potential language interpreter/translator.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a computer implemented language interpretation/translation system.

FIG. 2 illustrates an example of a digital display rendered by the mobile computing device after a request for language interpretation/translation is sent to the routing engine.

FIG. 3 illustrates the internal components of the augmentation engine illustrated in FIG. 1.

FIG. 4 illustrates a process that may be utilized to augment a language interpretation/translation session with one or more augmented features.

### DETAILED DESCRIPTION

A configuration that provides an augmented voice-based language interpretation/translation session is provided. The configuration utilizes the capabilities of a smart computing device, e.g., smartphone, tablet device, smart wearable device, etc., to enhance a voice-based language interpretation/translation session with non-audio data to provide context to the user during the language interpretation/translation session. As an example, a profile picture of a language interpreter/translator may be provided to the user via a smartphone of the user to help the user select a language interpreter/translator and/or visualize an in-person communication during the language interpretation/translation. Such visualization may help the user better understand the language interpretation/translation.

The configuration solves the technology-based problem of obtaining contextual non-audio data for a language interpretation/translation session occurring through voice-based communication devices. Such a solution is necessarily rooted in technology as utilization of conventional telephones did not allow for providing and receiving such non-audio data since conventional telephones were limited to the utilization of audio data. The configuration utilizes smart device based technology as smart devices are technology-based devices that allow for non-audio based rendering functionality, e.g., display video, images, text, etc.

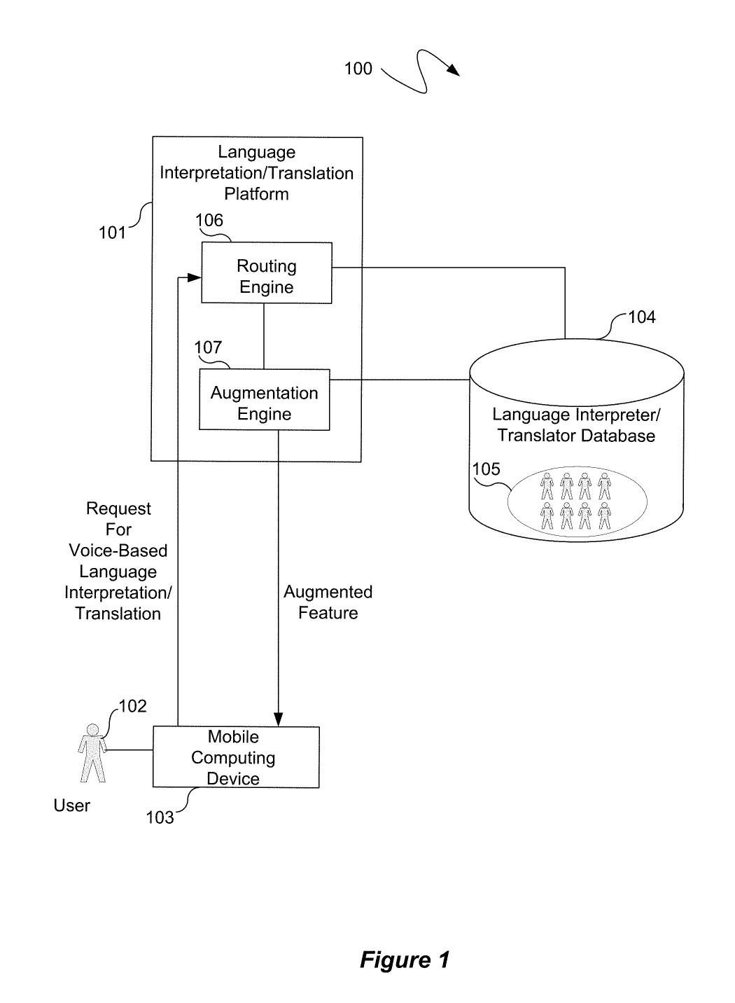

FIG. 1 illustrates a computer implemented language interpretation/translation system 100. The computer implemented language interpretation/translation system 100 has a language interpretation/translation platform 101 that provides voice-based language interpretation/translation products and/or services or access to such products and/or services.

For instance, one or more users 102 associated with a mobile computing device 103 may send a request from the mobile computing device 103 to the language interpretation/translation platform 101 to initiate a voice-based language interpretation/translation session. The voice-based language interpretation/translation session provides a voice-based interpretation/translation from a first spoken language, e.g., Spanish, into a second spoken language, e.g., English. For example, multiple users 102 speaking different languages may utilize the speakerphone functionality of the mobile computing device 103 to speak with a language interpreter/translator 105 provided via the language interpretation/translation platform 101 to interpret/translate the conversation. As another example, multiple users 102 with different mobile computing devices 103 may each communicate with the language interpretation/translation platform 101 to participate in a language interpretation/translation session with the language interpreter/translator 105. As yet another example, one user 102 utilizing the mobile computing device 103 may request language interpretation/translation.

The mobile computing device 103 may be a smartphone, tablet device, smart wearable device, laptop, etc. In one embodiment, the mobile computing device 103 has one or more capabilities for augmenting the voice-based language interpretation/translation session. For example, the mobile computing device may augment the voice-based language interpretation/translation session with video, images, text, etc.

The mobile computing device 103 sends a request for voice-based language interpretation/translation to a routing engine 106 of the language interpretation/translation platform 101. The routing engine 106 is in operable communication with a language interpreter/translator database 104 that stores data associated with the language interpreters/translators 104 that perform voice-based language interpretation/translation services for the language interpretation/translation platform 101. For instance, the data may include language interpreter/translator availability, estimated wait time, pictures, etc.

In one embodiment, the routing engine 106 selects an available language interpreter/translator 105 from the language interpreter/translator database 104 and routes the request for voice-based language interpretation/translation from the mobile computing device 103 to the available language interpreter/translator 105. In another embodiment, the routing engine 106 receives data from the mobile computing device 103 that indicates a preference of the user 102 for a particular language interpreter/translator 105. The data may be an additional request, a preference stored in a user profile on the mobile computing device 103, etc. Such data may be automatically sent from the mobile computing device 103 or may be inputted by the user 102 as a routing request. The routing engine 106 may then route the request from the mobile computing device 103 to the intended language interpreter/translator 105 or may inform the user 102 of the estimated wait time for the intended language interpreter/translator 105 so that the user 102 may choose to wait or select another language interpreter/translator 105 that has quicker availability.

The voice-based language interpretation/translation session that is performed between the language interpreter/translator 105 and the one or more users 102 may be implemented via a voice-based communication such as a telephone call. Therefore, the mobile computing device 103 has telephone communication capability to establish a telephone call with a communication device associated with the language interpreter/translator 105.

In one embodiment, the language interpretation/translation platform 101 also has an augmentation engine 107 that augments the language interpretation/translation session with one or more augmented features. An augmented feature is content that is distinct from the language interpretation/translation. Further, the augmented feature is content that is accessible via the capabilities of a mobile computing device 103, e.g., smartphone, tablet, smart wearable, or other smart device.

As an example, the augmentation engine 107 may retrieve a picture of the selected language interpreter/translator 105 and send the picture to the mobile computing device 103 for display by the mobile computing device 103. As a result, the user 102 may better understand the language interpretation/translation provided by the language interpreter/translator 105 by visualizing an in-person language interpretation/translation with the language interpreter/translator 105.

As yet another example, the augmentation engine 107 may determine an estimated wait time for a selected language interpreter/translator 105. The augmentation engine 107 may then send that estimated wait time to the mobile computing device 103 for display to the user 102 so that the user 102 may determine prior to initiation of the language interpretation/translation session if the user 102 wants to continue to wait for the selected language interpreter/translator or have the voice communication transferred to another language interpreter/translator 105. The mobile computing device 103 may then send a communication to the routing engine 106 so that the routing engine 106 may route the voice communication to a different language interpreter/translator 105 that is either immediately available or has a less of an estimate wait time than the previous language interpreter/translator 105.

As another example, the augmentation engine 107 may send one or more messages, e.g., text-based, to the mobile computing device 103 in the language of the user 102. The messages may include instructions based upon the content of the language interpretation/translation session. For instance, the user 102 may inform the language interpreter/translator 105 during the language interpretation/translation session that the user 102 is in a particular foreign country and that the user 102 needs directions to a local event. The language interpreter/translator 105 may then prepare a set of instructions in the language of the user 102 that may be sent via the augmentation engine 107 to the mobile computing device 103.

In one embodiment, the augmentation engine 107 may augment the language interpretation/translation session before, during, or after the language interpretation/translation session with an augmented feature based on input received from the user 102 via the mobile computing device 103. In another embodiment, the augmentation engine 107 may augment the language interpretation/translation session before, during, or after the language interpretation/translation session with an augmented feature based on data that is automatically received from the mobile computing device 103 without an input by the user 102, e.g., GPS coordinates determined by the mobile computing device 103.

In various embodiments, the user 102 may provide a voice based input or a non-voice based input via the mobile computing device 103. For example, the user 102 may provide a voice based input via a voice recognition system to accept a potential language interpreter/translator from the plurality of language interpreters/translators 105 after receiving an augmented feature. As another example, the user 102 may provide a keypad entry, e.g., a numerical selection via a DTMF tone, to accept or reject the language interpreter/translator after receiving an augmented feature. As yet another example, the user 102 may send a text-based message or a video-based message to the routing engine that accepts or rejects the potential language interpreter/translator from the plurality of language interpreters/translators 105 after receiving an augmented feature.

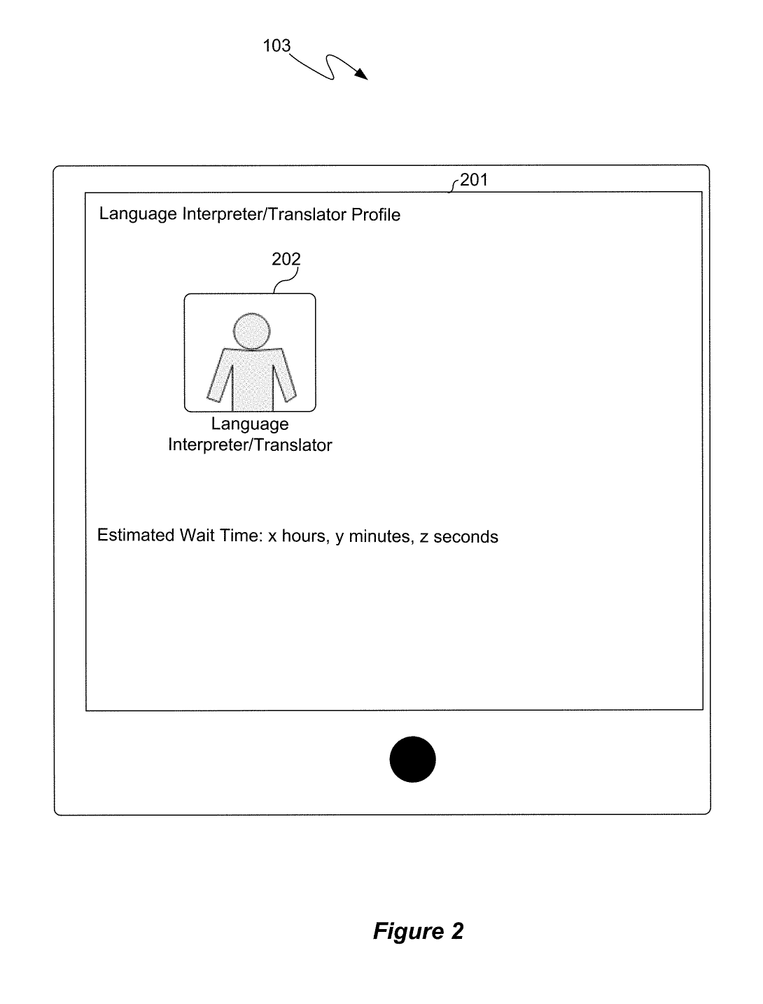

FIG. 2 illustrates an example of a digital display 201 rendered by the mobile computing device 103 after a request for language interpretation/translation is sent to the routing engine 107. For instance, a language interpreter/translator profile may be sent from the routing engine 107 to the mobile computing device 103. The language interpreter/translator profile may include a picture 202 of the language interpreter/translator 105. Alternatively, or in addition, the language interpreter/translator profile may include language interpreter/translator data such as languages spoken, particular skill sets, etc. The language interpreter/translator profile may be utilized by the user 102 to determine whether or not to select the language interpreter/translator 105 for the voice-based language interpretation/translation session. After such selection, the language interpreter/translator profile may continue to be displayed by the mobile computing device 103 during the language interpretation/translation session so that the user 102 may visualize an in-person language interpretation/translation. Further, the digital display 201 may additionally, or alternatively, display an estimated wait time for a particular language interpreter/translator 105 prior to the routing of the voice communication by the augmentation engine 107 to a selected language interpreter/translator 105.

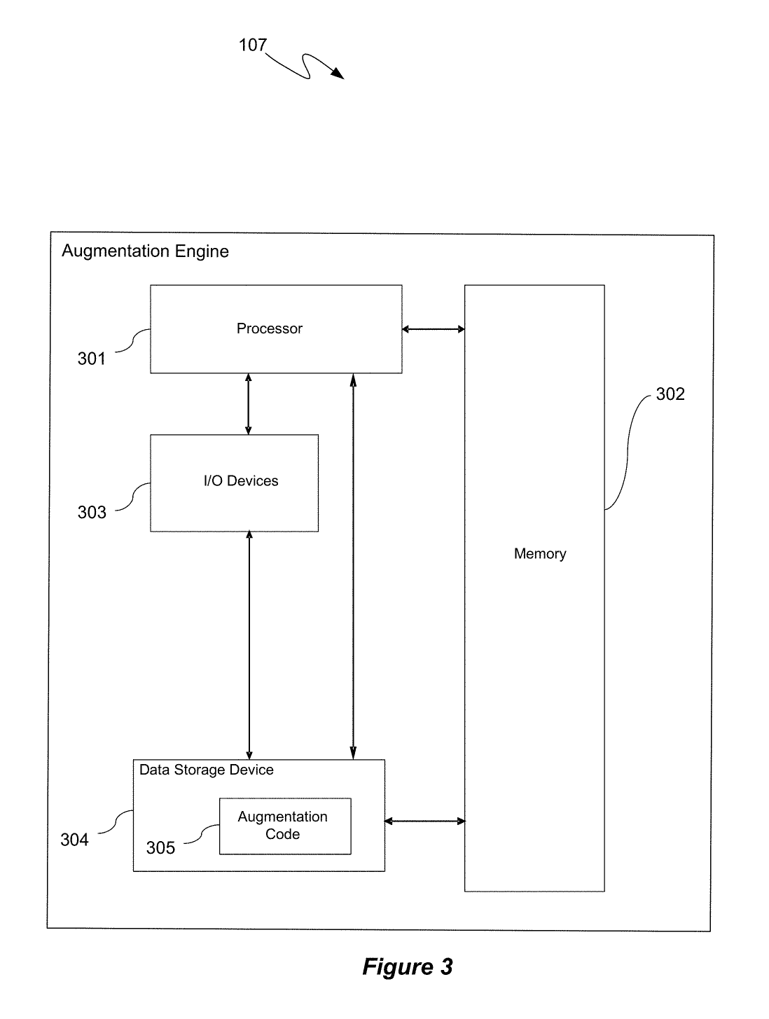

FIG. 3 illustrates the internal components of the augmentation engine 107 illustrated in FIG. 1. In one embodiment, the augmentation engine 107 is implemented utilizing a specialized processor that is configured to automatically generated features that may be sent to the mobile computing device 103 for augmentation with a language interpretation/translation session. The augmentation engine 107 comprises a processor 301, a memory 302, e.g., random access memory (“RAM”) and/or read only memory (“ROM”), various input/output devices 303, e.g., a receiver, a transmitter, a user input device, a speaker, an image capture device, an audio capture device, etc., a data storage device 304, and augmentation code 305 stored on the data storage device 304. The augmentation code 303 is utilized by the processor 302 to generate features based upon contextual data, user profile data, and/or language interpreter/translator user profile data. In another embodiment, the augmentation engine 107 is implemented utilizing a general multi-purpose processor.

The augmentation code 305 illustrated in FIG. 3 may be represented by one or more software applications or a combination of software and hardware, e.g., using application specific integrated circuits (“ASIC”), where the software is loaded from a storage device such as a magnetic or optical drive, diskette, or non-volatile memory and operated by a processor 301 in a memory of a computing device. As such, the augmentation code 305 illustrated in FIG. 3 and associated data structures may be stored on a computer readable medium such as a computer readable storage device, e.g., RAM memory, magnetic or optical drive or diskette, etc. The augmentation engine 107 may be utilized for a hardware implementation of any of the configurations provided herein.

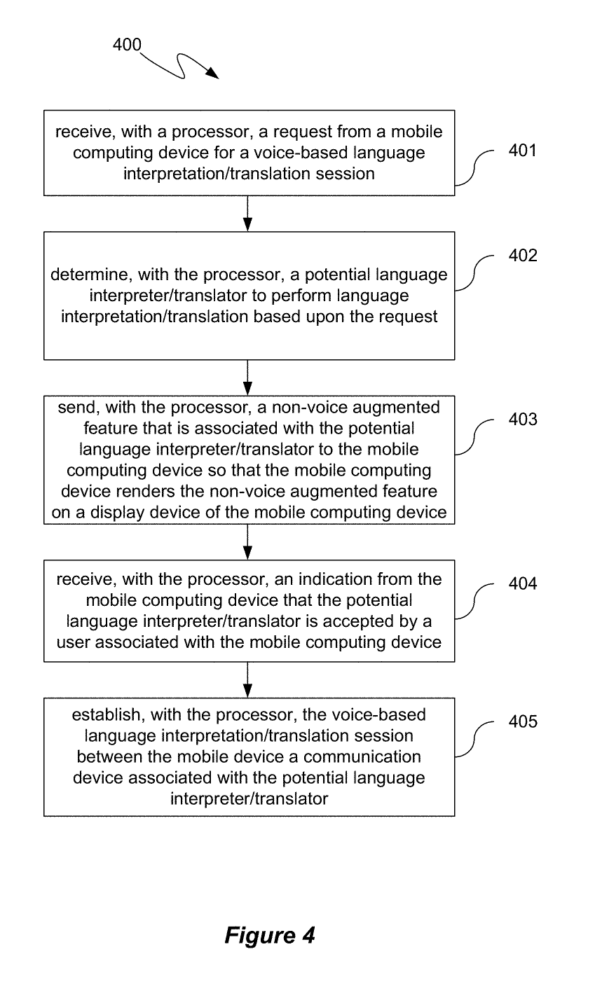

FIG. 4 illustrates a process 400 that may be utilized to augment a language interpretation/translation session with one or more augmented features. At a process block 401, the process 400 receives, with a processor, a request from a mobile computing device for a voice-based language interpretation/translation session. Further, at a process block 402, the process 400 determines, with the processor, a potential language interpreter/translator to perform language interpretation/translation based upon the request. In addition, at a process block 403, the process 400 sends, with the processor, a non-voice augmented feature that is associated with the potential language interpreter/translator to the mobile computing device so that the mobile computing device renders the non-voice augmented feature on a display device of the mobile computing device. At a process block 404, the process 400 receives, with the processor, an indication from the mobile computing device that the potential language interpreter/translator is accepted by a user associated with the mobile computing device. Further, at a process block 405, the process 400 establishes, with the processor, the voice-based language interpretation/translation session between the mobile device a communication device associated with the potential language interpreter/translator.

The processes described herein may be implemented in a specialized processor that is specifically configured to augment a language interpretation/translation session with one or more features. Alternatively, such processes may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium such as a computer readable storage device. The instructions may also be created using source code or any other known computer-aided design tool. A computer readable medium may be any medium capable of storing those instructions and include a CD-ROM, DVD, magnetic or other optical disc, tape, silicon memory, e.g., removable, non-removable, volatile or non-volatile, etc.

A computer is herein intended to include any device that has a general, multi-purpose or single purpose processor as described above. For example, a computer may be a PC, laptop computer, set top box, cell phone, smartphone, tablet device, smart wearable device, portable media player, video player, etc.

It is understood that the computer program products, apparatuses, systems, and processes described herein may also be applied in other types of apparatuses, systems, and processes. Those skilled in the art will appreciate that the various adaptations and modifications of the embodiments of the compute program products, apparatuses, systems, and processes described herein may be configured without departing from the scope and spirit of the present computer program products, apparatuses, systems, and processes. Therefore, it is to be understood that, within the scope of the appended claims, the present computer program products, apparatuses, systems, and processes may be practiced other than as specifically described herein.

1. A computer implemented language interpretation platform comprising:
a processor that receives a request from a mobile computing device for a voice-based language interpretation session with a remotely-located human language interpreter, determines a potential remotely-located human language interpreter to perform language interpretation based upon the request, sends a non-voice augmented feature that is associated with the potential remotely-located human language interpreter to the mobile computing device so that the mobile computing device renders the non-voice augmented feature on a display device of the mobile computing device, receives an indication from the mobile computing device that the potential remotely-located human language interpreter is accepted by a user associated with the mobile computing device, and establishes the voice-based language interpretation session between the mobile device and a communication device associated with the accepted remotely-located human language intepreter, the voice-based language interpretation session comprising a language interpretation of a first spoken language to a second spoken language such that the second language is provided in a voice format without the non-voice augmented feature.

2. The computer implemented language interpretation platform of claim 1, wherein the non-voice augmented feature is sent to the mobile computing device prior to the establishment of the voice-based language interpretation session.

3. The computer implemented language interpretation platform of claim 2, wherein the non-voice augmented feature is a picture of the potential remotely-located language interpreter.

4. The computer implemented language interpretation platform of claim 2, wherein the non-voice augmented feature is a text-based indication of a waiting time for the potential remotely-located language interpreter.

5. The computer implemented language interpretation platform of claim 1, wherein the non-voice augmented feature is sent to the mobile computing device subsequent to the establishment of the voice-based language interpretation session.

6. The computer implemented language interpretation platform of claim 5, wherein the non-voice augmented feature is a text-based set of instructions in a language spoken by the user for the user to perform an action.

7. The computer implemented language interpretation platform of claim 6, wherein the processor generates the text-based set of instructions based upon data received from the mobile computing device.

8. The computer implemented language interpretation platform of claim 1, wherein the mobile computing device has telephone-based communication capabilities.

9. The computer implemented language interpretation platform of claim 1, wherein the processor further routes the request to the communication device associated with the potential remotely-located language interpreter.

10. The computer implemented language interpretation platform of claim 1, wherein the processor further receives an indication from the mobile computing device that a previous potential remotely-located language interpreter is rejected by the user associated with the mobile computing device.

11. A computer program product comprising a non-transitory computer readable storage device having a computer readable program stored thereon, wherein the computer readable program when executed on a computer causes the computer to:
receive, with a processor, a request from a mobile computing device for a voice-based language interpretation session, the voice-based language interpretation session comprising a language interpretation of a first spoken language to a second spoken language such that the second language is provided in a voice format without a non-voice augmented feature;
determine, with the processor, a potential remotely-located language interpreter to perform language interpretation/translation based upon the request;
send, with the processor, the non-voice augmented feature that is associated with the potential remotely-located language interpreter/translator to the mobile computing device so that the mobile computing device renders the non-voice augmented feature on a display device of the mobile computing device;
receive, with the processor, an indication from the mobile computing device that the potential remotely-located language interpreter/translator is accepted by a user associated with the mobile computing device; and
establish, with the processor, the voice-based language interpretation/translation session between the mobile device a communication device associated with the potential remotely-located language interpreter.

12. The computer program product of claim 11, wherein the non-voice augmented feature is sent to the mobile computing device prior to the establishment of the voice-based language interpretation session.

13. The computer program product of claim 12, wherein the non-voice augmented feature is a picture of the potential remotely-located language interpreter.

14. The computer program product of claim 12, wherein the non-voice augmented feature is a text-based indication of a waiting time for the potential remotely-located language interpreter.

15. The computer program product of claim 11, wherein the non-voice augmented feature is sent to the mobile computing device subsequent to the establishment of the voice-based language interpretation session.

16. The computer program product of claim 15, wherein the non-voice augmented feature is a text-based set of instructions in a language spoken by the user for the user to perform an action.

17. The computer program product of claim 16, wherein the processor generates the text-based set of instructions based upon data received from the mobile computing device.

18. The computer program product of claim 11, wherein the mobile computing device has telephone-based communication capabilities.

19. The computer program product of claim 11, wherein the computer is further caused to route, with the processor, the request to the communication device associated with the potential remotely-located human language interpreter.

20. The computer program product of claim 11, wherein the computer is further caused to receive, with the processor, an indication from the mobile computing device that a previous potential remotely-located human language interpreter is rejected by the user associated with the mobile computing device.
